(19) United States
(12) Patent Application Publication
(10) Pub. No.: US 2025/0085426 A1
(43) Pub. Date: Mar. 13, 2025

(54) COHERENT LIDAR SYSTEM FOR CAPTURING THE SURROUNDINGS WITH BINARY POWER MODULATION AND LITTLE PROCESSING OUTLAY

(71) Applicant: Continental Autonomous Mobility Germany GmbH, Ingolstadt (DE)

(72) Inventor: Markus Wintermantel, Lindau (DE)

(73) Assignee: Continental Autonomous Mobility Germany GmbH, Ingolstadt (DE)

(21) Appl. No.: 18/827,990

(22) Filed: Sep. 9, 2024

(30) Foreign Application Priority Data
Sep. 8, 2023 (DE) 10 2023 208 722.7

(51) Int. Cl. G01S 17/58; G01S 7/481; G01S 7/484; G01S 7/4865; G01S 17/931

(52) U.S. Cl. CPC G01S 17/58; G01S 7/4814; G01S 7/4817; G01S 7/484; G01S 7/4865; G01S 17/931

(57) ABSTRACT

A coherent lidar system for capturing surroundings emits a power-modulated signal which is realized by irregular switching on and off. The signals reflected back are received and digitized in a receive sequence, wherein the variable dimensions time shift and frequency shift of signals reflected by objects are determined from the receive sequence by digital signal processing. A two-dimensional correlation filtering is used for the dimensions time shift and frequency shift, or a discrete Fourier transform is calculated to reduce the required computing outlay, wherein the respective frequencies are determined from values of said Fourier transform, wherein the receive sequence is turned back in each case in frequency regarding the respective frequencies. The object distance is determined from values of this respective correlation and the radial relative speed of the respective object is determined from the respective frequency.

### CROSS-REFERENCE TO RELATED APPLICATIONS

This application claims priority to German patent application No. 10 2023 208 722.7 filed Sep. 8, 2023, which is hereby incorporated by reference.

### TECHNICAL FIELD

The technical field relates to a coherently working lidar system in particular for capturing the surroundings for motor vehicle applications.

### BACKGROUND

Motor vehicles are increasingly being equipped with driver assistance systems which capture the surroundings with the aid of sensor systems and deduce automatic reactions of the vehicle and/or instruct, in particular warn, the driver as a result of the traffic situation recognized therefrom. A distinction is made between comfort and safety functions.

In the meantime, however, developments are going in an even more far-reaching direction. The driver is no longer only assisted, but rather the driver's task is increasingly being handled autonomously by the vehicle, i.e., the driver is being increasingly replaced; this is referred to as autonomous driving.

In particular, autonomous driving requires sensors with highly accurate information about the surroundings, which is easy to evaluate by machines. Radar systems are limited in their angular accuracy and separation capability and cannot satisfactorily meet these high capturing requirements on their own or even in combination with camera systems, at least not yet. For this reason, lidar systems, which have a similarly high angular resolution (horizontally and vertically) to a camera, but which additionally supply distance information and separation capability in each pixel, are also deployed in parallel. Today, so-called time-of-flight lidar systems which deal with electromagnetic radiation in the sense of particles and which can, thus, only measure the distance, but not the relative speed directly, are mostly deployed. However, the focus is now also increasingly on coherently working lidar systems which deal with electromagnetic radiation in the sense of waves (like radar systems) and, therefore, can also directly measure the relative speed of objects via the Doppler effect. Further advantages of coherent lidar systems are that they are, on the one hand, robust to extraneous radiation from other sources (e.g., due to other lidar systems or sunlight) and that, on the other hand, they have a higher sensitivity at higher distances and, therefore, allow higher ranges. In addition, coherent lidar systems are credited with a higher potential for high semiconductor integration, which promises lower manufacturing costs.

In the case of coherent lidar systems, the emitted electromagnetic wave is modulated, i.e., it changes in at least one of the parameters of amplitude, frequency or phase over time—otherwise no distance measurement would be possible. The most commonly used modulation in coherent lidar systems is the linear frequency modulation (FMCW=frequency modulated continuous wave), which mostly consists of two frequency ramps, the slopes of which have opposite algebraic signs. However, said modulation does have ambiguity problems in particular in the case of multiple reflections in the same beam direction and, in addition, the production of a highly linear frequency change is elaborate. Said disadvantages do not occur or occur less in the case of a phase modulation (e.g., with pseudo-random change over discrete phase values), but the digital evaluation of the received signals is, however, more elaborate and the approaches proposed in the prior art (e.g., in the article “Phase-Coded-Based Modulation for Coherent Lidar” by Sebastian Banzhaf and Christian Waldschmidt, published in IEEE TRANSACTIONS ON VEHICULAR TECHNOLOGY, VOL. 70, NO. 10, October 2021) are associated with disadvantages, in particular in terms of sensitivity and, therefore, range.

Therefore, there remains an opportunity to provide a simple modulation and an associated low-outlay signal evaluation for a coherent lidar system, without disadvantages, in particular in terms of sensitivity and, therefore, range, being linked therewith.

### SUMMARY

The core idea is that a power modulation is realized with the aid of a switch or changeover switch, which represents an elegant and cost-effective approach, and that the signal evaluation for determining the relative speed and distance of objects is implemented in a low-outlay manner in particular by using a comparatively low number of fast Fourier transforms.

The advantages result from the fact that a lidar system having a high performance and a low price can be realized.

The coherently working lidar system for capturing the surroundings emits a power-modulated signal which is realized by irregular, in particular pseudo-random switching on and off, wherein the switching off does not have to be perfect, but rather is only characterized by a complete shutdown of the power or only by a significant power reduction, and the times of the switching on and off form a subset of an equidistant time raster. It further receives the signals reflected back from objects, which are delayed with respect to the emitted signal by the distance-dependent transit time and are shifted in frequency by the relative speed-dependent Doppler effect, converts these into a low-frequency signal by mixing and digitizes them in a receive sequence in order to determine the variable dimensions time shift and frequency shift of signals reflected by objects from said receive sequence in digital signal processing means. According to the invention, a two-dimensional correlation filtering is used for the variable dimensions time shift and frequency shift of signals reflected by objects, preferably realized with the aid of a hardwired digital circuit, or to reduce the required computing outlay a discrete Fourier transform is firstly calculated, preferably with the aid of a fast Fourier transform, over the values of the receive sequence, if necessary extended by zeroes; secondly, the respective frequencies are determined from values of said discrete Fourier transform, in particular of peaks lying above a first detection threshold; thirdly, the receive sequence is turned back in each case in frequency regarding the respective frequencies; fourthly, a correlation is determined in each case between the thus generated sequence and the modulation sequence, in particular formed from the switching values 1 and 0, or the modulation sequence adjusted by its mean value; and, fifthly, the respective time shift and, therefore, object distance are determined from values of this respective correlation, in particular of peaks lying above a second detection threshold, and the radial relative speed of the respective object is determined from the respective frequency.

In an advantageous configuration, the power modulation is realized by a changeover switch between two transmit paths which consequently have inverse power modulation with respect to one another.

The first detection threshold for peaks of the discrete Fourier transform preferably lies less far above the noise than the second detection threshold for peaks of the respective correlation.

Advantageously, the power modulation sequence can be periodically repeated, wherein in particular during a continual scanning of the laser beam the cyclical property of the modulation and receive sequence can be exploited, and a capturing can be realized in different directions in each case.

The laser beam can further be continually scanned and overlapping sections of a long, if necessary, periodic power modulation sequence can be utilized for the successive capturing directions.

According to an advantageous configuration, the laser frequency continually changes, at least in some sections, preferably with an at least approximately linear progress, so that the entire modulation is composed of a line modulation and a frequency modulation.

It is preferably considered that the frequency is shifted both by the relative speed-dependent Doppler effect and by the distance-dependent transit time due to the linear frequency change, in particular in that the object distance is determined from the established time shift, and the radial relative speed of the object is determined from the established frequency shift less its contribution caused by the time shift.

A correct sign determination of the receive frequency and, therefore, the clear determination of the relative speed of objects when using a real-valued mixer can further be realized in that it is considered that, in particular in the case of objects which are further away, only a relative speed hypothesis is possible or at least more plausible because of the known transit time-dependent component of the frequency shift.

A correct sign determination of the receive frequency and, therefore, the clear determination of the relative speed of objects when using a real-valued mixer can advantageously be realized in that the steepness of the frequency change is varied and data regarding different steepness are captured and evaluated for an object and the fact is utilized that the two frequency shift effects of relative speed and transit time then bear a different relation to one another, in particular characterized in that the algebraic sign, but not the amount of the steepness of the frequency change is varied, so that the two frequency shift effects of relative speed and transit time having different algebraic signs are added and thus the algebraic sign of the receive frequency can be determined.

The frequency change can further be utilized in order to change the beam direction, in particular continually, at least in some sections, in order to thus be able to capture data for multiple pixels in different directions.

### BRIEF DESCRIPTION OF THE DRAWINGS

FIG. 1 shows the coherent lidar system with binary power modulation.

FIG. 2 shows the progress of a pseudo-random binary power modulation.

In FIG. 3, the real part of the low-frequency, analog receive signal and the associated sampling values for one object are depicted.

FIG. 4 shows the amount of the two-dimensional correlation of the receive sequence for two objects.

FIG. 5 shows the FFT of the receive sequence for the example of two objects.

FIG. 6 shows the two one-dimensional correlations for the example of two objects.

In FIG. 7, a lidar system having two transmit-receive paths is depicted, wherein the power modulation is realized by a changeover switch between the two paths.

FIG. 8 shows the linear change in the transmit frequency during the binary power modulation.

FIG. 9 shows the receive frequency temporally shifted to the transmit frequency in the case of no Doppler shift (that is to say, at zero relative speed).

### DETAILED DESCRIPTION

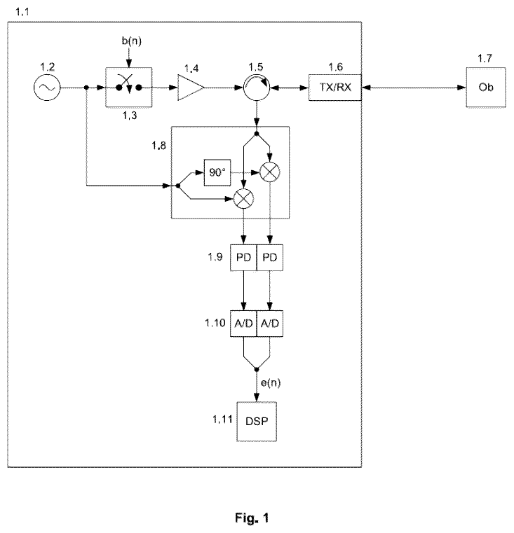

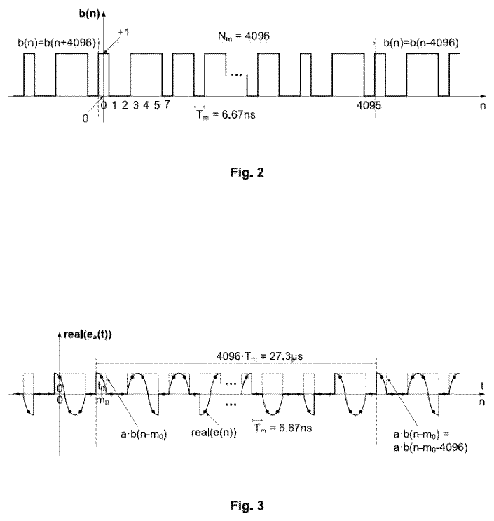

FIG. 1 schematically shows a coherent lidar system 1.1. A coherent signal in the wavelength range of approximately λ=1550 nm is produced with the laser source 1.2; the coherence length is at least multiple microseconds and the frequency is constant. Subsequently, the signal arrives at a switch 1.3, via which it can be switched on and off for the further signal path. The switching (that is to say, switching on or off) only takes place in a fixed raster of, e.g., 6.67 ns and happens, for example, pseudo-randomly, i.e., the switch state is only changed with a rate or probability of 50% after Tₘ=6.67 ns. Said binary power modulation can also be considered as an amplitude modulation having a modulation sequence b(n), which consists of the values +1 and 0; its progress is depicted, by way of example, in FIG. 2. The modulation is repeated with the period Nₘ=4096, that is to say every 27.3 μs (in particular for acquiring data for multiple capturing directions, that is to say pixels). The modulated signal passes through an amplifier 1.4, a circulator 1.5 (that is to say, a transceiver switch), is radiated via a transceiver unit 1.6 and partially reflected back from an object 1.7; with a delay which is dependent on the object distance r and, therefore, variable

$${t}_{0} = 2 r / c , \qquad ( 1 a )$$

wherein c=3·10⁸ m/s is the speed of light, and with a frequency shift which is dependent on the radial relative speed v and, therefore, variable, which is produced by the Doppler effect

$${f}_{D} = 2 v / λ \qquad ( 1 b )$$

said signal is then acquired by the transceiver unit 1.6 and is routed via the circulator 1.5 into the further receive path. In a complex-valued mixer 1.8 (also referred to as an IQ mixer), the modulated received signal is superimposed with the unmodulated laser signal and is converted with the aid of the photodiode unit 1.9 into a complex-valued, low-frequency signal; the frequency fₑ of said signal corresponds to the Doppler shift f_{D} according to relationship (1b):

$${f}_{e} = {f}_{D} = 2 v / λ , \qquad ( 2 )$$

the modulation of said signal is delayed by the signal transit time with respect to that of the transmit signal. In FIG. 3, the real part of said low-frequency, analog receive signal eₐ(t) is depicted in the case of one object. Subsequently, the signal is sampled and digitized in an analog-to-digital convertor unit 1.10 with the sampling frequency fₛ=150 MHz, i.e., every Tₛ=6.67 ns—the resulting values of the real part are characterized in FIG. 3 as points; because here the sampling time Tₛ=6.67 ns and modulation time Tₘ=6.67 ns are equal, the number Nₛ of the sampling values per modulation period is also equal to the raster length Nₘ thereof, that is to say Nₛ=Nₘ=4096, so that a N=4096 without an index is utilized below for both. The complex-valued sampling signal e(n), also referred to hereinafter as the receive sequence, can be described as follows:

$$e ( n ) = a \cdot b ( n - {m}_{0} ) \cdot exp ( 2 π \hat{J} \cdot n / N \cdot {k}_{0} ) , \qquad ( 3 a )$$

wherein it is assumed here that the transit time t₀ is an integral multiple m₀ of the modulation time Tₘ=6.67 ns and, therefore, the sampling time is Tₛ=6.67 ns as well:
and

$${m}_{0} = {t}_{0} / {T}_{m} = 2 r / c / {T}_{m} \qquad ( 3 b )$$

$${k}_{0} = N \cdot {T}_{s} \cdot {f}_{D} = N \cdot {T}_{s} \cdot 2 v / λ \qquad ( 3 c )$$

which corresponds to the Doppler shift is likewise integral; a is the complex-valued amplitude of the receive sequence, “exp” denotes the exponential function and ĵ is the imaginary unit.

The complex-valued receive sequence e(n) according to relationship (3) relates to an individual object without a longitudinal extent, and to an ideal receiver (with virtually infinite receive bandwidth; real receivers distort the pulses in particular for a good signal-to-noise ratio, but which should not be taken into account here for the time being). In actual fact, there can be multiple and/or longitudinally extended objects, and an additional noise rₑ(n) is generated in the receiver, in particular due to thermal noise; this then produces the receive sequence

$$e ( n ) = {sum}_{i = 1 , ... , I} [ {a}_{i} \cdot b ( n - {m}_{0 , i} ) \cdot exp ( 2 π \hat{J} \cdot n / N \cdot {k}_{0 , i} ) ] + {r}_{e} ( n ) , \qquad ( 4 )$$

wherein “sum_{i=1, . . . ,I}” constitutes the sum function over the index i=1, . . . ,I of the I non-extended individual objects.

The discrete transit times m_{0,i} and the discrete Doppler shifts k_{0,i} of the I objects are to be established from the receive sequence e(n) of the period of time n=0,1, . . . , N−1. For a determination which is as accurate as possible, that is to say a separation of the signal and noise which is as good as possible and, therefore, for maximum sensitivity and range of the lidar system, so-called optimal filtering is to be applied, that is to say filtering by correlation between the receive sequence e(n) and the two-dimensional space ê_{m,k}(n) of the possible ideal amplitude-standardized receive sequences of an individual object:

$${\hat{e}}_{m , k} ( n ) = b ( n - m ) \cdot exp ( \hat{J} 2 π \cdot n / N \cdot k ) where m = 0 , ... , \\ M - 1 and k = 0 , ... , N - 1 ; \qquad ( 5 )$$

M−1 corresponds to the largest object distance which is to be assumed or is of interest, and it is assumed for the Doppler shift k that it can assume any values. This therefore produces the two-dimensional correlation E_{m,k}:

$${E}_{m , k} = {sum}_{n = 0 , ... , N - 1} ( e ( n ) \cdot conj ( {\hat{e}}_{m , k} ( n ) ) = {sum}_{n = 0 , ... , N - 1} ( e ( n ) \cdot b ( n - m ) \cdot exp ( - \hat{J} 2 π \cdot n / N \cdot k ) ) , m = 0 , ... , M - 1 and k = 0 , ... , N - 1 , \qquad ( 6 )$$

wherein “conj” denotes the complex-conjugate formation and the modulation sequence b(n) does not change because of its real-valuedness. The correlation E_{m,k} has peaks (often also referred to as power peaks) at the positions (m,k)=(m_{0,i}, k_{0,i}) of objects; FIG. 4 shows the amount of the two-dimensional correlation for two objects of the same receive amplitude at (m_{0,1},k_{0,1})=(150, 3000) and (m_{0,2},k_{0,2})=(51, 500), which corresponds to their distances r₁=150 m and r₂=51 m and the radial relative speeds v₁=−31.1 m/s and v₂=14.2 m/s (in the case of the range k=0, . . . , N−1 unsymmetrically selected above for k, k>N/2 negative Doppler frequencies and, therefore, negative relative speeds are assigned; a negative relative speed means that the object moves away relatively). As can be seen in FIG. 4, the two-dimensional correlation has, in the case of the Doppler shifts koi of the objects, an approximately constant base level from which the peaks stand out by approximately 6 dB; this is explained in greater detail later, and a possible approach to suppressing said base level is also presented.

That is to say, in order to determine the distance rᵢ and the radial relative speed vᵢ of objects, the peaks of the two-dimensional correlation E_{m,k} are to be established, wherein peaks are only used, which lie above a respective detection threshold, in order to distinguish them from the system noise and the aforementioned base level during the Doppler shift of objects. According to relationships (3b) and (3c), rᵢ and vᵢ can be calculated as follows from the positions of the peaks, that is to say the discrete transit times m_{0,i} and the discrete frequency shifts k_{0,i}:

$${r}_{i} = {m}_{0 , i} \cdot c \cdot {T}_{m} / 2 , \qquad ( 7 a )$$

$${v}_{i} = {k}_{0 , i} \cdot λ / ( 2 N \cdot {T}_{s} ) . \qquad ( 7 b )$$

That is to say, the distance and relative speed of multiple objects can be directly and clearly determined from a modulation sequence. This is a great advantage over the linear frequency modulation frequently utilized in the case of coherent lidar systems having two frequency ramps, the slopes of which have opposite algebraic signs—ambiguities are unavoidable there in the case of multiple objects.

The calculation of said two-dimensional correlation and its downstream evaluation take place in the digital signal processing unit 1.11. It constitutes a high outlay with the order of N·M·N. However, the above relationship (6) can also be considered as a discrete Fourier transform over the product e(n)·b(n−m), n=0, . . . , N−1 which is to be determined for each m=0, . . . , M−1; the discrete Fourier transform (DFT) is calculated by way of the fast Fourier transform (FFT):

$${E}_{m , k} = {FFT}_{k} ( e ( n ) \cdot b ( n - m ) ) where m = 0 , ... , M - 1 , \qquad ( 8 )$$

wherein k=0, . . . ,N−1 is the output dimension of the FFT, that is to say the discrete frequency, so that the computational outlay is reduced to the order of M·N·log₂(N).

The previously considered receive sequence e(n) of the period of time n=0,1, . . . ,N−1 and the associated correlation E_{m,k} refer to an individual capturing direction, that is to say based on the horizontal and vertical direction, to one pixel. In actual fact, approximately 160,000 capturing directions, that is to say pixels, are covered in each capturing cycle of 50 ms; this is typically realized by a combination of parallel transmitter and receiver, that is to say parallel capturing of pixels, and scanning, that is to say sequential capturing of pixels. A parallel transmitter and receiver means that all of the elements 1.4-1.10 of the lidar system 1.1 in FIG. 1 (if necessary, apart from a joint focusing and beam sweeping device in the transceiver unit 1.6) exist multiple times, e.g., 64 times. The scanning can happen, e.g., thanks to sequential switching or thanks to continual mechanical movement (e.g., of a mirror); during continual scanning, it is also possible that pixels partially overlap, that is to say that the back ones of the N values of the receive sequence e(n) of one pixel are also utilized as front values of the next pixel. If it is now assumed that M=250 (corresponds to the maximum distance of 249 m in the case of the above interpretation), then the FFT of length 4096 from relationship (8) is to be calculated 800 million times per second. It is not possible to realize this many FFT calculations by way of microprocessors or DSPs (Digital Signal Processors); the clock frequency of such processors typically lies in the range of 1 GHZ, i.e., almost one complete FFT of length 4096 would have to be calculated per clock frequency, but modern processors can, as a general rule, only carry out up to the order of 100 multiplications and additions per clock frequency, even when using parallel vectorial computing units, which is several orders of magnitude below the requirement for an FFT of length 4096. For this reason, it is only possible to implement this many FFTs by way of special computational logic implemented in hardware (that is to say, a largely hardwired digital arithmetic circuit); however, said computational logic is generally also associated with a large implementation outlay (large chip surface) and high electrical power consumption.

For this reason, an approach is to now be proposed here, which manages with less computational outlay. According to relationship (3a), the receive sequence eᵢ(n) generated by an object i in the period of time n=0, . . . ,N−1 is:

$${e}_{i} ( n ) = {a}_{i} \cdot b ( n - {m}_{0 , i} ) \cdot exp ( 2 π \hat{j} \cdot n / N \cdot {k}_{0 , i} ) where n = 0 , … , N - 1 , \qquad ( 9 )$$

i.e., it corresponds to a complex oscillation having the Doppler frequency k_{0,i}, which is half set to zero in a pseudo-random manner. The Doppler frequency can be determined by way of a DFT or FFT.

To this end, over the receive sequence

$${\tilde{e}}_{1} ( n ) = e ( n ) where n = 0 , … , N - 1 \qquad ( 10 )$$

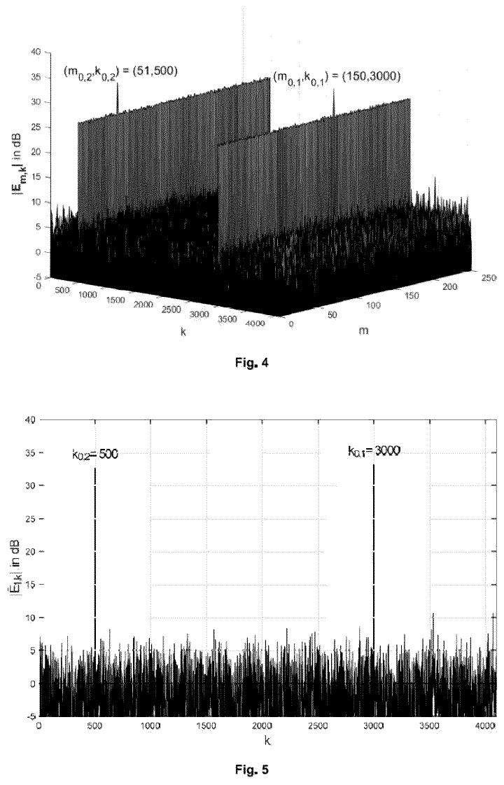

a FFT is formed:

$${\tilde{E}}_{1 , k} = {FFT}_{k} ( {\tilde{e}}_{1} ( n ) ) = {FFT}_{k} ( e ( n ) ) where n = 0 , … , N - 1 , \qquad ( 11 )$$

wherein k=0, . . . ,N−1 is the output dimension of the FFT, that is to say the discrete frequency. In FIG. 5, said FFT is depicted in amount terms for two objects of the same receive amplitude at (m_{0,1},k_{0,1})=(150, 3000) and (m_{0,2},k_{0,2})=(51, 500), i.e., peaks occur at the discrete Doppler frequencies k_{0,1}=3000 and k_{0,2}=500. Since due to the modulation b(n-m_{0,i}), half of the respective oscillation is set to zero in a pseudo-random manner, a noise component is generated per object, which is 10·log₁₀(N/2)=33 dB under the respective peak; due to the two considered objects having the same receive amplitude, the noise 30 dB generated by them then lies below the peaks. In FIG. 5, it is assumed that the signals reflected by the objects are so strong that the noise generated by them because of their modulation dominates with respect to the system noise, that is to say the signal-to-noise ratio is 30 dB. For weaker reflections, the signal-to-noise ratio is limited by the system noise. It should already be noted here that the signal-to-noise ratio is reduced in terms of the system noise by 6 dB with respect to an unmodulated receive signal of the same amplitude since only half of the signal duration is of course effective for the coherent integration of the FFT (in the other half, the useful signal is zero). When referring to a receive signal of the same average received power (that is to say, also based on the same average transmission power), the reduction of the signal-to-system noise ratio by the modulation is still 3 dB.

The peaks of the FFT \tilde{E}_{1,k} are checked for a detection threshold. The frequencies k_{0,j} of the J peaks lying above the detection threshold are utilized for the further processing; typically, these peaks are seen in two adjacent FFT values (since they do not lie—as considered in the above example—at an integral Doppler index k_{0,j}), so that their exact location, that is to say a non-integral frequency k_{0,j}, can then be determined by interpolation. Said frequencies k_{0,j} correspond at least approximately to the Doppler frequencies k_{0,i} of the objects or a subset of these (for objects with very low reflectivity, it can be that they do not result in a peak above the detection threshold).

For the output dimension of the FFT, that is to say the discrete frequency, the non-symmetrical range k=0, . . . ,N−1 was considered above, as is generally the case; the actual relative speeds and, therefore, Doppler frequencies can assume both algebraic signs, so that the upper range, e.g., the upper half of k=0, . . . ,N−1, is to be illustrated for negative values by subtracting N.

So far, the case has been considered that no window function is utilized for the FFT, that is to say no multiplication of the input values of the FFT by a kind of bell curve; this would only be necessary or useful if two objects having a similar relative speed and notably different reflection strength can occur at the same distance in one pixel and are to be separated. In particular, when no window function is utilized at the input of the FFT, the sensitivity at the output of the FFT is then reduced (that is to say, the detection capacity of objects having a weak reflectivity and/or high distance), when the Doppler index corresponding to the relative speed is not integral, that is to say the peak is divided between two adjacent FFT values. Said effect can be reduced by selecting the length of the FFT to be higher than that of its input signal, i.e., zeros are appended to the input signal, which is referred to as zero padding.

The Doppler frequencies k_{0,i} of the objects are produced from the FFT \tilde{E}_{1,k}; in order to determine their transit times, a second calculation step is necessary. According to relationship (9), the receive sequence eᵢ(n) generated by an object i is a modulation sequence b(n-m_{0,i}) shifted by the transit time m_{0,i}, on which the Doppler frequency k_{0,i} is superimposed (of course, also multiplied by the complex signal amplitude aᵢ). In order to eliminate the superimposed Doppler frequency in each case, the receive sequence e(n) is in each case turned back by the frequency k_{0,j}:

$${\tilde{e}}_{2 , j} ( n ) = e ( n ) \cdot exp ( - 2 π \hat{j} \cdot n / N \cdot {k}_{0 , j} ) where \\ n = 0 , … , N - 1 and j = 1 , … J . \qquad ( 12 )$$

The thus modified sequences \tilde{e}_{2,j}(n) include j shifted modulation sequences aᵢ·b(n-m_{0,i}) in the corresponding index; contributions of objects having other Doppler frequencies k_{0,i} (that is to say, k_{0,i}≠k_{0,j}) constitute an uncorrelated modulation sequence for b(n), since they are still modulated with the difference frequency k_{0,i}−k_{0,j}. For this reason, the sequences \tilde{e}_{2,j}(n) can now be correlated with the modulation sequence b(n):

$${\tilde{E}}_{2 , j , m} = {sum}_{n = 0 , … , N - 1} ( {\tilde{e}}_{2 , j} ( n ) \cdot b ( n - m ) ) where \\ m = 0 , … , M - 1 and j = 1 , … J ; \qquad ( 13 a )$$

since the modulation sequence b(n) has the period N, this can also be understood to be a cyclical correlation when using the cyclically shifted modulation sequence b(mod_{N}(n−m)(“mod_{N}” constitutes the modulo function regarding module N):

$${\tilde{E}}_{2 , j , m} = {sum}_{n = 0 , … , N - 1} ( {\tilde{e}}_{2 , j} ( n ) \cdot b ( {mod}_{N} ( n - m ) ) ) where \\ m = 0 , … , M - 1 and j = 1 , … J . \qquad ( 13 b )$$

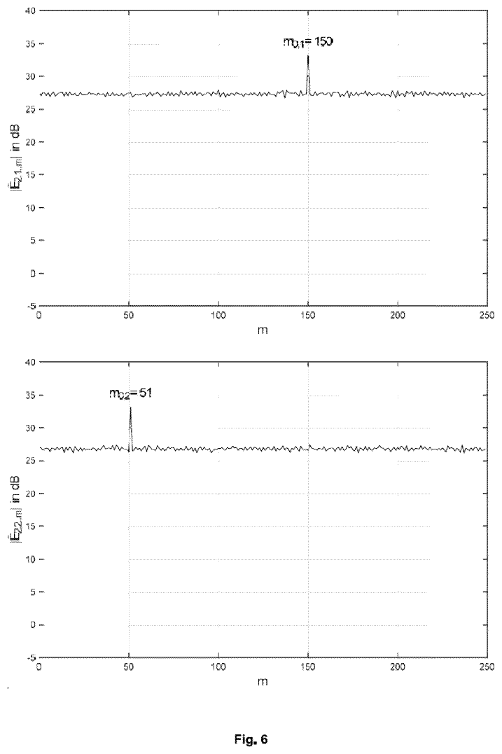

In said one-dimensional correlations \tilde{E}_{2,j,m}, peaks occur at the corresponding discrete transit times m_{0,i} of the objects. For the above example with the two objects at (m_{0,1},k_{0,1})=(150, 3000) and (m_{0,2},k_{0,2})=(51, 500), the amounts of the two correlations \tilde{E}_{2,1,m} for \tilde{e}_{2,1}(n) for k_{0,1}=3000 as well as \tilde{E}_{2,2,m} for \tilde{e}_{2,2}(n) for k_{0,2}=500 are depicted in FIG. 6; the peaks lie at the corresponding discrete transit times m_{0,1}=150 and m_{0,2}=51. In the general case of a non-integral discrete transit time m_{0,i}, the peak extends, during suitable measures (e.g., distorting of the modulation pulses in the receiver by optimal filtering to an approximately triangular shape) over two adjacent values of m, and its non-integral position can be established by interpolation. The Doppler frequency k_{0,i}=k_{0,j} of the object is produced from the index j of the correlation \tilde{E}_{2,j,m}, at which the peak occurs, and the Doppler frequency k_{0,j} belonging to said j. Thus, the distances and radial relative speeds of objects in the respective capturing direction can be determined from peaks of the correlations \tilde{E}_{2,j,m} lying above a detection threshold. It should be noted that contributions of objects having, in each case, other Doppler frequencies k_{0,i} (that is to say k_{0,i}≠k_{0,j}) only result in noise in the respective correlations, that is to say no peaks above a detection threshold, because of the fact that they are not correlated with b₂(n); in the case of approximately equally strong reflection signals from objects, said noise is notably below the peaks of interest and does not therefore conceal these—only when reflection signals from objects are considerably different can objects having a strong reflection signal conceal weak reflection signals having another Doppler frequency by way of their noise.

As can be seen in FIG. 6, the cyclical correlations \tilde{E}_{2,j,m} have an approximately constant base level from which the peaks stand out by approximately 6 dB. This is justified in that the modulation sequence b(n) and, therefore, also the receive sequences belonging to the individual objects after turning back by their Doppler frequency are not free of mean values; their mean value is half the amplitude in the switched-on, that is to say, active state. If there are multiple objects having different distances and having different receive levels at a radial relative speed, that is to say one Doppler frequency in one pixel, the peaks of the weaker objects are generally concealed by the base level of the strongest object and can no longer be detected. In order to avoid this, the base level can be subtracted or eliminated; one approach to this is that the modulation sequence utilized for the cyclical correlation is adjusted by the mean value 0.5, that is to say, the modulation sequence

$$\underline{b} ( n ) = b ( n ) - 0.5 \qquad ( 14 )$$

is utilized. The disadvantage of this is that the signal-to-system noise ratio is then 3 dB worse (the correlation then no longer constitutes an optimal filtering). For this reason, a two-step method can also be utilized, where the correlation according to relationship (13) is first used with the actual modulation sequence b(n), and thereafter—at least with a good signal-to-system noise ratio—an approach with an eliminated base level (of the mean value of the modulation sequence) is then executed. It should also be noted that if the base level in the correlation is eliminated, a noise still occurs outside the peaks, since the two factors of the correlation product there (receive sequence and shifted modulation sequences) are not correlated with one another and are thus added in a random manner, that is to say with a random algebraic sign; if—as in the case considered above—the period of the modulation sequence and the length of the evaluated receive sequence have the same value N, then this noise due to the signal 10·log₁₀(N)=36 dB lies below the peak, for a non-periodic modulation sequence it would only be 10·log₁₀(N/2)=33 dB, i.e. a design having the same period of the modulation sequence and length of the evaluated receive sequence (and therefore length of the correlation) is advantageous in this respect.

However, since in the vast majority of cases there is only one object at a radial relative speed in one pixel, a generally acceptable simplification is to only determine and to consider the maximum of the respective cyclical correlations \tilde{E}_{2,j,m}; if this maximum lies above a detection threshold, which is preferably derived from the system noise, then the result is an object detection. In the case of the cyclical correlations \tilde{E}_{2,j,m}, the signal-to-system noise ratio is 3 dB better than in the case of the FFT \tilde{E}_{1,k} for determining the Doppler frequencies, since in the case of the peaks of the correlation, the values which only contain system noise but no signal are suppressed by way of multiplying by the shifted modulation sequence assuming the value zero there—in the FFT, these values (50% of all values) also flow in and therefore increase the noise, but not the peak. For this reason, it makes sense to use a reduced detection threshold for the FFT (with the consequence that peaks generated by the noise are increasingly detected) and to only check for a stricter detection threshold (for the striven-for or permitted false positive rate) during the correlation. The only disadvantage can be that the correlation has to be calculated rather more frequently.

In the typical case of one object in one pixel, the evaluation explained above requires a FFT for the receive sequence e(n) in order to determine the Doppler frequency and a cyclical correlation in order to determine the transit time (the turning back of the Doppler frequency in relationship (12) is negligible compared to these two operations and is not considered for this reason). The cyclical correlation in the time range can also be realized by way of multiplying the FFTs in the frequency range with a subsequent inverse FFT (an inverse FFT requires the same computational outlay as the FFT itself); the FFT of the modulation sequence b(n) can be determined once a priori (and then utilized for all pixels, provided that the distance of the pixels and the period of the modulation sequence are identical), so that only the FFT of the receive sequence \tilde{e}_{2,1}(n) turned back in the Doppler frequency has to be determined (it should be noted that instead of turning back the Doppler frequency in the time range, a shift in the frequency range, that is to say of the FFT of \tilde{e}_{2,1}(n) could also be utilized, wherein then, however, only integral discrete Doppler frequencies would be possible, which generally brings disadvantages with it). Overall, that is to say that the outlay of three FFTs is incurred, whereas in the case of the two-dimensional correlation E_{m,k} according to relationship (8), a total of M=250 FFTs is to be calculated. This therefore results in a very strong reduction in the required computational outlay to a magnitude which modern DSPs having parallel vectorial computing units open up. It should also be noted that, despite the strong reduction in the computing power, the presented approach has the same sensitivity as the optimal two-dimensional correlation E_{m,k} according to relationship (8) since the full emitted signal energy (per pixel) becomes coherently effective (without it being integrated by way of noise from sections without a receive signal).

A similar reduction in the required computational outlay can also be realized by using a phase modulation and an evaluation, as described in the article “Phase-Coded-Based Modulation for Coherent Lidar” by Sebastian Banzhaf and Christian Waldschmidt, published in IEEE Transactions on Vehicular Technology, vol. 70, No. 10, October 2021. For the signal-to-system noise ratio, however, only half of the emitted signal energy (per pixel) becomes effective therein, whilst in the case of the approach according to the invention presented here, the full signal energy becomes effective in the correlation, which leads to a 3 dB better signal-to-system noise ratio. And in contrast to an approach described in the above article, arbitrary overlaps for two adjacent pixels can be realized, since the modulation sequence has a similar, pseudo-random structure over its entire period N (and is not divided into two separate sections).

If the peak power is restricted in the lidar system (e.g., by the amplifier 1.4) or significant electrical power is consumed (e.g. by the amplifier 1.4) for the open switch 1.3, the approach presented here of a power modulation, that is to say of switching on and off a signal, can at least partially lose the advantage described above in terms of the signal-to-system noise ratio. However, there are mostly multiple parallel transmit-receive paths in a lidar system in order to be able to realize the required number of pixels per cycle. For this reason, the power modulation can be achieved in such a way that there is a changeover switch between two transmit-receive paths, i.e. the signal is placed in a pseudo-random manner on one of the two transmit-receive paths. This is depicted in FIG. 7; the first transmit-receive path 7.5 receives the modulation signal b(n), the second transmit-receive path 7.6 receives the inverse modulation signal inv(b(n)) thereto, wherein the inverse function “inv” interchanges the values 0 and +1. The amplifier 7.4 is now situated in front of the changeover switch 7.3 and, consequently, has a constant output power over time. It should be noted that, of course, the unmodulated laser signal for the downmixing of the received signals goes into the transmit-receive paths, which is not explicitly depicted in FIG. 7 for the sake of simplicity.

So far, a perfect switch or changeover switch has been assumed, i.e., in the shutdown state the value at the output is zero, that is to say there is absolutely no signal. Real switches are not perfect, so that in the actually shutdown state there can still be a residual signal (which does, however, lie significantly below the full signal in the switched-on state). For the first calculation step, that is to say the determination of the FFT \tilde{E}_{1,k}, this is even of slight advantage (provided the phase is maintained in the downshifted state), since then the peaks increase slightly. During the second calculation step, that is to say the determination of the correlations \tilde{E}_{2,j,m}, the dynamic range slightly reduces, but this is not critical. For this reason, less good switches or changeover switches can also be used. In general, it should be emphasized that the generation of a modulation with switches or changeover switches is a very simple and inexpensive approach to realize.

In terms of the modulation sequence b₂(n), it should be noted that it cannot only be formed from a pseudo-random sequence, but rather also from a code, the autocorrelated part of which has small side lobes—e.g., from a gold code known from the literature. This can result in a higher dynamic range of the correlation, however only when there are no signal components (e.g., from objects of another relative speed) which constitute noise in the signal to be correlated and when corresponding counter-measures are taken against the correlation base level of objects explained above.

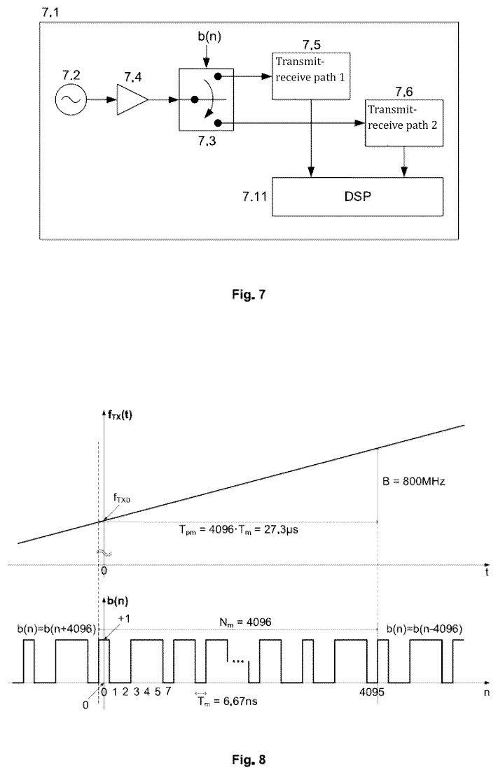

So far, it has been assumed that the frequency on which the power modulation sequence b(n) is imprinted is constant, that is to say does not change. An approach according to the invention will now be considered below that the frequency changes continually in a linear manner; this is depicted in FIG. 8, where the frequency of the laser source 1.2 and, therefore, the transmit frequency f_{TX}(t) increases linearly by B=800 MHz (that is to say, with an increase of B/Tₚₘ=29.3 MHz/μs) within a modulation period of the duration Tₚₘ=N·Tₘ=27.3 μs. That is to say, the general rule for the transmit frequency f_{TX}(t) is:

$${f}_{TX} ( t ) = {f}_{TX 0} + t \cdot B / {T}_{pm} where {T}_{pm} = N \cdot {T}_{m} . \qquad ( 15 )$$

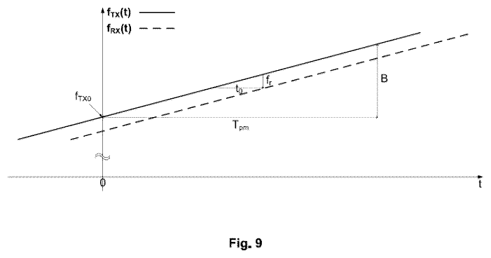

Without a Doppler shift (that is to say, if the initially assumed relative speed is zero) and as shown in FIG. 9, the frequency f_{TX}(t) of the received signal is correspondingly delayed because of the transit time to:

$${f}_{RX} ( t ) = {f}_{TX} ( t - {t}_{0} ) = {f}_{TX 0} + ( t - {t}_{0} ) \cdot B / {T}_{pm} , \qquad ( 16 )$$

and is therefore shifted downwards with respect to the transmit frequency f_{TX}(t). Said frequency shift fᵣ due to the transit time is

$${f}_{r} = - {t}_{0} \cdot B / {T}_{pm} \qquad ( 17 a )$$

and with the transit time to according to relationship (1a):

$${f}_{r} = - 2 r / c \cdot B / {T}_{pm} ; \qquad ( 17 b )$$

for the example of an object distance r=150 m and, therefore, a transit time t₀=1 μs as well as the above modulation values, the frequency shift due to the transit time is fᵣ=−29.3 MHz. According to relationship (17b), the frequency shift due to the transit time fᵣ is proportional to the object distance r.

The entire frequency shift and, therefore, the frequency fₑ of the receive signal following mixing is now composed of the Doppler shift f_{D} according to relationship (1b) and the above component due to the transit time fᵣ according to relationship (17b):

$${f}_{e} = {f}_{D} + {f}_{r} = 2 v / λ - 2 r / c \cdot B / {T}_{pm} . \qquad ( 18 )$$

This is the only difference from the initially considered case of a constant transmit frequency. The modulation sequence shifted by the transit time is still imprinted on said receive frequency, so that the relationship (3a) still applies to the receive sequence e(n) following sampling and digitization, wherein the following now applies to the discrete receive frequency k₀ instead of relationship (3c):

$${k}_{0} = N \cdot {T}_{s} \cdot ( {f}_{D} + {f}_{r} ) = N \cdot {T}_{s} \cdot 2 \cdot v / λ - N \cdot {T}_{s} \cdot 2 \cdot r / c \cdot B / {T}_{pm} , \qquad ( 19 a )$$

and using the discrete transit time m₀ according to (3b) as well as Tₚₘ=N·Tₘ:

$${k}_{0} = N \cdot {T}_{s} \cdot ( {f}_{D} + {f}_{r} ) = N \cdot {T}_{s} \cdot 2 \cdot v / λ - {m}_{0} \cdot {T}_{s} \cdot B . \qquad ( 19 b )$$

Consequently, the evaluation approaches presented above can still be used—both the two-dimensional correlation E_{m,k} according to relationship (8), that is to say also the cost-effective two-step method by way of FFT \tilde{E}_{1,k} according to relationship (11), and the one-dimensional correlation \tilde{E}_{2,j,m} according to relationship (13), which is preferably realized with the aid of two FFTs (per object). The only difference is that for the determination of the radial relative speed vᵢ of the respective object, the component due to the transit time of the discrete frequency shifts k_{0,i} is to be taken into account—with the aid of relationship (19b), this results in:

$${v}_{i} = λ / ( 2 N \cdot {T}_{s} ) \cdot ( {k}_{0 , i} + {m}_{0 , i} \cdot {T}_{s} \cdot B ) ; \qquad ( 20 )$$

that is to say that, in contrast to the original relationship (7b), the contribution due to the transit time −m_{0,i}·Tₛ·B, which is proportional to the discrete transit time −m_{0,i}, is to be subtracted from the discrete frequency shift k_{0,i}.

The reasons for a superimposed, preferably at least approximately linear frequency modulation can, firstly, be a continual scanning of the capturing direction by way of a frequency change, secondly, a more accurate distance and/or relative speed measurement (in particular, when using different signs for the frequency change) and, thirdly, when using a real-valued mixer, the at least partially clear sign determination of the receive frequency.

Finally, the following should be noted: On the basis of the above application examples, the depicted considerations and explanations according to the invention can be transferred to general designs and parameter interpretations in a simple manner, i.e., they can also be applied to other numerical values. For this reason, general parameters are also frequently indicated in formulas and images.

1. A coherently working lidar system for capturing the surroundings, which
emits a power-modulated signal which is realized by irregular, pseudo-random switching on and off, wherein the switching off is achieved by a complete shutdown of the power or only by a significant power reduction, and the times of the switching on and off form a subset of an equidistant time raster,
receives the signals reflected back from objects, which are delayed with respect to the emitted signal by the distance-dependent transit time and are shifted in frequency by the relative speed-dependent Doppler effect, converts them into a low-frequency signal by mixing and digitizes them in a receive sequence, and
determines the variable dimensions time shift and frequency shift of signals reflected by objects from said receive sequence in digital signal processing means, wherein
a two-dimensional correlation filtering is used for the variable dimensions time shift and frequency shift of signals reflected by objects, realized with the aid of a hardwired digital circuit, or to reduce the required computing outlay
a discrete Fourier transform is calculated with the aid of a fast Fourier transform, over the values of the receive sequence, if necessary extended by zeroes,
the respective frequencies are determined from values of said discrete Fourier transform, in particular of peaks lying above a first detection threshold,
the receive sequence is turned back in each case in frequency regarding the respective frequencies,
a correlation is determined in each case between the thus generated sequence and the modulation sequence, in particular formed from the switching values 1 and 0, or the modulation sequence adjusted by its mean value, and
the respective time shift and, therefore, object distance are determined from values of this respective correlation, in particular of peaks lying above a second detection threshold, and the radial relative speed of the respective object is determined from the respective frequency.

2. The lidar system according to claim 1, in which the power modulation is realized by a changeover switch between two transmit paths which consequently have inverse power modulation with respect to one another.

3. The lidar system according to claim 1, in which the first detection threshold for peaks of the discrete Fourier transform lies less far above the noise than the second detection threshold for peaks of the respective correlation.

4. The lidar system according to claim 1, in which the power modulation sequence is periodically repeated, wherein in particular during a continual scanning of the laser beam the cyclical property of the modulation and receive sequence is exploited, and a capturing is realized in different directions in each case.

5. The lidar system according to claim 1, in which the laser beam continually scans and overlapping sections of a long, if necessary, periodic power modulation sequence are utilized for the successive capturing directions.

6. The lidar system according to claim 1, in which the laser frequency continually changes, at least in some sections, with an at least approximately linear progress, so that the entire modulation is composed of a line modulation and a frequency modulation.

7. The lidar system according to claim 6, in which it is considered that the frequency is shifted both by the relative speed-dependent Doppler effect and by the distance-dependent transit time due to the linear frequency change, in particular in that the object distance is determined from the established time shift, and the radial relative speed of the object is determined from the established frequency shift less its contribution caused by the time shift.

8. The lidar system according to claim 6, in which a correct sign determination of the receive frequency and, therefore, the clear determination of the relative speed of objects when using a real-valued mixer are realized in that it is considered that, in particular in the case of objects which are further away, only a relative speed hypothesis is possible or at least more plausible because of the known transit time-dependent component of the frequency shift.

9. The lidar system according to claim 6, in which a correct sign determination of the receive frequency and, therefore, the clear determination of the relative speed of objects when using a real-valued mixer are realized in that the steepness of the frequency change is varied and data regarding different steepness are captured and evaluated for an object and the fact is utilized that the two frequency shift effects of relative speed and transit time then bear a different relation to one another, in particular characterized in that the algebraic sign, but not the amount of the steepness of the frequency change is varied, so that the two frequency shift effects of relative speed and transit time having different algebraic signs are added and thus the algebraic sign of the receive frequency can be determined.

10. The lidar system according to claim 6, in which the frequency change is utilized in order to change the beam direction, in particular continually, at least in some sections, in order to thus be able to capture data for multiple pixels in different directions.
